(19) United States
(12) Patent Application Publication
(10) Pub. No.: US 2020/0211044 A1
(43) Pub. Date: Jul. 2, 2020

(54) MERCHANT SERVICES PROVIDER SYSTEM AND METHOD(S) OF USE THEREOF

(71) Applicant: Kellan A. Dall, Highlands Ranch, CO (US)

(72) Inventor: Kellan A. Dall, Highlands Ranch, CO (US)

(21) Appl. No.: 16/730,507

(22) Filed: Dec. 30, 2019

Related U.S. Application Data
(60) Provisional application No. 62/786,741, filed on Dec. 31, 2018.

(51) Int. Cl. G06Q 30/02; G06Q 20/40; G06Q 20/20

(52) U.S. Cl. CPC G06Q 30/0206; G06Q 20/204; G06Q 20/407

(57) ABSTRACT

A merchant services provider system and method(s) of use thereof is described. Embodiments of the system and method can be implemented to create a binding agreement between a merchant and a merchant services provider for payment processing services. Typically, a mobile application (or web site) can be implemented to receive information from a merchant for underwriting and soliciting a rate offer by the merchant for payment processing services. A merchant services provider can decide whether to accept or deny the rate offer based on information provided by the merchant.

### CROSS-REFERENCE TO RELATED APPLICATION

This application claims the benefit of U.S. Provisional Application No. 62/786,741, filed Dec. 31, 2018.

### BACKGROUND

Traditionally, to sign up for a merchant processing account a merchant fills out an application with one or more merchant services providers. The providers will provide the merchant with a rate offer, which the merchant can either accept or reject. Throughout the history of merchant services providers and the payments industry, merchants have always been given rate choices. Merchants have never had the ability to bid or state the rates they are willing to pay.

A merchant looking for the best price for its payment processing may need to apply with several providers to find a price structure it hopes is fair and equitable. In order to be more certain that the proffered rates are fair and no higher than necessary, a merchant would need to spend an inordinate amount of time investigating how the payment processing industry works. Even then, the merchant is tasked with ascertaining what is fact or fiction even though it may not have the experience or knowledge to decipher the information. Even so, the merchant is still left with accepting one of the offers put to it by one or more payment providers with little ability to negotiate its own rate. Often after going through the process the merchant is left with the sinking feeling it is paying too much for its payment processing.

### BRIEF DESCRIPTION OF THE DRAWINGS

FIG. 1 is a block diagram of a merchant services provider system according to one embodiment of the present invention.

FIG. 2 is a flowchart of a method for creating a binding contract between a merchant and a merchant services provider according to one embodiment of the present invention.

FIG. 3 is a flowchart of a method for creating a binding contract between a merchant and a merchant services provider for an additional location according to one embodiment of the present invention.

FIG. 4 is a flowchart of a method for requesting and generating a merchant statement analysis according to one embodiment of the present invention.

FIG. 5 is a flowchart of a method for creating a referral partner account according to one embodiment of the present invention.

FIG. 6 is a flowchart of a method for retaining a merchant according to one embodiment of the present invention.

### DETAILED DESCRIPTION

Embodiments of the present invention include a merchant services provider system and a method(s) of use thereof. The system and method can be implemented to allow a merchant to provide a rate the merchant may be willing to pay for payment processing services and a merchant services provider can either accept or decline the rate based on one or more parameters. Embodiments of the system and method can be broadly construed and can be applied to a variety of payment processing systems (not just credit card processing, for instance) and conditions.

The system can typically include, but is not limited to, a server, a network, and one or more merchant devices. A merchant services provider can provide a mobile application and/or a website hosted on the server. A merchant can input information via the mobile application (or website) to offer a rate the merchant may be willing to pay for payment processing services. Of note, the website and mobile application may be hosted on a different server or computing device of the merchant services provider. In such an instance, the merchant services provider may have control over the data stored by the remotely located server.

One embodiment of the method includes the steps of, but is not limited to, a merchant (i) accessing a website or opening a mobile application establishing a connection with a merchant services provider (MSP) over a network connection, (ii) creating a user account with the MSP and completing a payment processing application, (iii) providing the rates on a transaction the merchant may be willing to pay, and (iv) receiving notice from the MSP, after the MSP has completed underwriting, that the rate proposal has either been accepted or declined. Of note, the merchant may only be told whether the rate they proffered has been accepted if the application was accepted by underwriting. Typically, the merchant may not be notified of acceptance or denial of the rate offer if the application is declined by underwriting. As can be appreciated, a merchant may not be able to fish for the lowest rate by inputting false data into the application to see if the proffered rate may be accepted.

Another embodiment of a method can include the steps of, but is not limited to, a merchant services provider (MSP), typically comprising a computer system, (i) receiving an application for merchant services from a merchant including desired processing rates of the merchant, (ii) determining whether the requested processing rates are acceptable based on information provided in the application and processing rate parameters of the MSP, (iii) performing an underwriting step to confirm the veracity of the application of the merchant, and (iv) transmitting notice to the merchant that the processing rate proposal has been accepted or declined. The merchant may only be told whether the rate they proffered has been accepted if the application was accepted by underwriting.

Yet another embodiment of a method includes various operations of both the merchant and the merchant service provider (MSP) to apply for and gain approval for a new merchant account wherein the merchant requests a rate structure rather than the rate structure being dictated by the MSP. The method (or process) can typically be performed on hardware running appropriate software that can also be connected to a general information network, such as the interne. The specifics of the process and variations thereof are described in greater detail below.

Initially, a merchant who desires payment processing services contacts a provider typically through a network connection over an information network to begin a process of obtaining payment processing services. This can include accessing a web site hosted by or on behalf of the merchant services provider or opening an application previously downloaded and installed on a computing device of the merchant to begin the application process.

The merchant may then provide basic information about a business of the merchant to create a profile. The basic information can typically include, but is not limited to, a business name, a name of the contact person, a business address, and a name or other identifying information of the person or entity that referred the merchant to the provider. In some instance, the merchant may add a referral partner number for the person or entity that pointed them to the merchant services provider.

The merchant can then be prompted to create a user name and password. The previously entered merchant information can be transmitted electronically over the network to the provider's computer and/or server. The provider's computer can create a record for the merchant, generate a username (typically the email address) and temporary password, and sends the temporary password to the merchant's email. After the merchant has received the temporary password, the merchant can use the temporary password in the mobile application or webpage and the merchant will be given an option to create a new password of its choosing. This iterative process will permit the provider's computer to verify the veracity of the merchant's email address. Other username and password generation methodology can be utilized as well with or without a subsequent verification routine.

Once the provider has created a record for the merchant and verified the email address, or other contact information (e.g., phone number, mailing address, etc.), the merchant can be prompted to prepare an application for payment processing services provided through or placed by the provider. The specific information required of a merchant can vary but will typically include at least the merchant's MCC code and an estimated annual credit card volume.

The application may also include a section in the mobile application or web site that will provide disclosures to the merchant, such as the terms and conditions. The disclosures may include the terms of the contract that may be created if the provider accepts the merchant's proffered rates, the number of times a merchant may rebid (if any) if initial proffered rates are not accepted, terms and conditions concerning the contractual relationship of the parties such as when the account is activated if the rates are accepted by the provider, and under what conditions the parties may terminate the contract, such as if it is determined that the merchant has not accurately represented the information provided in the application. The terms and conditions can include billing parameters, such as daily, monthly, or bill back. The terms and conditions can also pertain to processing methods such as whether the card is present, the card is keyed in, or processing is online. The types of processing equipment and/or software might be specified. Additionally, the approval timeframes and underwriting requirements can be laid out.

Typically, the merchant must e-sign the application agreeing to the contractual terms and conditions prior to being directed to a “State Your Rate” section of the mobile application or web site page. As can be appreciated, the pertinent application information can be transmitted from the merchant device to the provider's computer for storage and processing. Embodiments of the system and method may require that the merchant agree to be bound by the terms and conditions of the provider should the provider accept the merchant's rates for a period of time prior to the provider accepting the rates proffered by the merchant. In this fashion, the acceptance of the proffered rates by the provider is all that is necessary to consummate the contract between the provider and the merchant. It is appreciated that in other embodiments the required assent to the provider's terms and conditions in the form of an e-signature could be submitted simultaneously with the merchant's proffered rates or before the acceptance of the rates are provided by the provider.

The merchant may then be prompted to enter rates the merchant proposes to pay for payment processing services. The nature of the proffered rates can vary but typically takes the form of a percentage or basis point plus a transaction fee for each payment processed, which typically comprise a percentage of the total transaction value that is charged by the merchant. Once the merchant has entered a first rate offer into the mobile application or onto the webpage, a submit button can be pressed to send the rate information to the provider's computer. In submitting the proffered rates, the merchant can be making an offer that, if accepted by the provider, creates a binding contract between the merchant and the provider subject to the terms and conditions previously agreed to by the merchant.

In one example pricing structure, the merchant can be charged a standard Interchange rate (or pass through) which is a cost charged by the card issuers (e.g., Capital One, Chase, etc.) and the card brands (Visa, Master Card, Amex, etc.) and an additional amount (the Plus) charged by the payment merchant services provider. The amount of the stated rates is those above the interchange rate as the interchange rate is not subject to modification by the merchant services provider. Of important consideration is that embodiments of the present invention are not limited to a particular pricing structure. Other embodiments can be adapted to any suitable pricing structure including, but not limited to, flat rate pricing, tiered pricing, cost plus pricing, cash discount pricing, or subscription pricing structures. In some embodiments, the merchant can be permitted to choose the pricing structure it desires to bid upon.

At some point in the process, the merchant services provider performs an underwriting analysis of the merchant to verify the veracity of the information provided in the merchant's application. This process can include verifying the merchant's address, the type of business, legal status, signer/guarantor credentials, annual revenues, and other pertinent information. The underwriting analysis can be performed by the merchant services provider or an independent company or organization hired for this purpose. The underwriting step can be performed at any suitable point in the process.

Further, different types of underwriting analysis can be performed at different times during the process. For instance, a cursory underwriting analysis can be performed as an initial screening early in the process to determine whether moving to the application stage or the state your rate stage of the process is appropriate with a more detailed underwriting analysis being performed only after the merchant's offered rate has been determined acceptable. The underwriting can be carried out as an automated computer process, by one or more people, or a combination thereof. Typically, the step of accepting the merchant's rate offer is not made until the underwriting step has been completed. The status of the merchant's rate bid, accepted or declined, may not be revealed to the merchant until some form of underwriting analysis is completed and the merchant is approved.

In some instances, an instant (or near instant) underwriting process can be performed for increasing the time to get a merchant signed to a deal. For instance, some deals may be auto-approved based on instant underwriting. Factors determining the auto-approval can vary but typically include a credit score of the signor based on the entered social security number or employer identification number. In this case, a merchant may be able to find out if their rates were accepted at a faster rate of time. Of note, even if a deal is auto-approved, the deal may still undergo further detailed underwriting where the deal could be declined by the merchant services provider.

After the application has been completed and submitted, the merchant may enter their proffered rate. The provider's computer/server can receive the proffered rate and processes the offer to determine whether to accept it. The process may be as simple as referencing as lookup table stored in a database file to determine whether the merchant's proffered rates are greater than or lower than the minimum acceptable levels for a given MCC and annual or monthly volume. If the proffered rate is greater than the minimum for a certain volume, the merchant's offer can be accepted and notice can be sent by any suitable means back to the merchant (e.g., email, a notice pushed on the merchant's device, etc.). Acceptance of the rates, as mentioned, consummates the contract between the parties once (as applicable) the application is accepted through underwriting.

If the proffered rate is too low for the provider to accept, the merchant will be notified as such. If the merchant's application is not accepted by underwriting, the merchant will not typically be notified that the rate bid was declined for being too low. The merchant will typically be notified only that the deal is declined based on the information provided in the application section. This limits the chance that people will go through the system with fake application information to simply find out what rates would be accepted or declined. In at least some embodiments, the system will only notify the merchant that an initial rate bid was too low/declined if the application itself has been approved by underwriting. Typically, if the application was accepted by underwriting, the merchant can be given a second chance to state a rate. In other variations, the merchant may not be given another opportunity, and in yet other variations the user can be given more than one additional chance. As can be appreciated, if the number of opportunities provided to merchant to name its rate is large, the merchant is more likely to use the iterative process to try and determine the lowest rate the provider will accept for a certain volume level.

Part of the application submitted by the merchant can include information related to hardware used by the merchant for payment processing. The information provided by the merchant related to payment processing hardware can be reviewed by the provider. Of note, the provider may delay (or pend) a deal based on the information entered by the merchant related to the payment processing hardware. In such an instance, the provider may still make a determination on the proffered rate and send the application to underwriting. However, if the provider determines the hardware is not acceptable, the provider may send a notification to the merchant indicating a deal is declined without disclosing whether the rate proffered by the merchant was acceptable.

The foregoing process conveys the basic operations or steps utilized in embodiments of the method and/or system. It is to be appreciated numerous additional features can be incorporated into the method and/or system. For instance, the method and system may require a merchant to choose payment processing equipment for purchase or lease, or indicate it is using equipment it already owns prior to permitting the merchant to state its rate. The merchant services provider may also offer a free equipment option (e.g., virtual terminal) for the merchant to select. Other options for free equipment may be available and a merchant does not need to purchase equipment or place a monetary amount as collateral to seek a deal with the merchant services provider. The system may also give the merchant the opportunity to add additional locations to be serviced by the provider. This can occur before and/or after the proffered rates are accepted and include the ability to purchase, lease, or choose additional equipment. Additionally, the system can incorporate a referral feature wherein referral partners can receive bonuses based on merchants they have referred signing up with the provider.

In another variation of the described embodiment, a statement analysis can be performed by the merchant services provider prior to the merchant stating its desired rates. This way the merchant can make a rate offer based on full knowledge of its current situation. Further, the associated website may include an educational section wherein existing merchants and new merchants alike can read explanations about how the payment processing system works. This information will assist the merchant in making a rate offer that is reasonable and more likely to be accepted. The merchant services provider may also include a rate guide to assist a merchant in making an offer. The rate guide can include, but is not limited to, high or low prompts, past rate offers, and/or current processing rates being paid derived from a merchant statement analysis.

Embodiments of the system and method may not be limited to rate pricing structures. The system and method can be able to incorporate any type of rate pricing structures. Rate pricing structures including, but not limited to, flat-rate, tiered, interchange plus, cost plus, passthrough, subscription pricing, cash discount pricing or any other available rate pricing structures. The system and method can be incorporated by any type of payment processing for any person, merchant, business type, Merchant Category Code (MCC), or business category.

The system and method may not be limited to billing structures. The system and method can incorporate billing structures including, but not limited to, monthly billing, daily billing, bill back, recurring, one-time billing, or any other available billing structure.

The system and method may not be limited to specific types of payment processing. The system and method may be able to incorporate any type of payment processing including, but not limited to, credit card processing, debit card processing, check card processing, pin debit processing, gift card processing, check processing, ACH processing, cash advance processing, EBT, fuel card processing, lodging processing, cash discount processing, retail, restaurant, lodging, hospitality, medical, moto, e-commerce, mobile, or any other available payment processing structure or method.

The system and method may not be limited to specific payment processing procedures. The system and method can allow merchants to process payments or transactions through whatever means necessary or available to the given merchant or business type.

The system and method may not be limited to specific payment processing equipment or systems. The system and method may be able to incorporate any type of payment processing equipment or systems including, but not limited to, point-of-sale terminals, point-of-sale cash register, point-of-sale software, point-of-sale integrations, online or offline gateways, mobile devices, mobile apps, card readers, check readers, scanning devices, contactless devices, imprinting devices, or any other available payment processing software or hardware.

The system and method may not be limited to specific underwriting types or approval timeframes. The system and method may be able to incorporate any type of underwriting, underwriting timeframes, approval methods, and/or timeframes.

The system and method may not be limited to specific payment funding types or timeframes. The system and method may be able to incorporate any type of payment funding within all timeframes including, but not limited to, instant funding, next day funding, 24-hour funding, person to person, or any other available funding methods and timeframes.

The system and method may not be limited to any specific payment card brands, card issuers, payment networks, payment processors, payment security structures or limitations, banking institutions, ACH processors, payment processing sellers or resellers, acquiring banks, acquirers or issuing banks, payment facilitators, payment service provider, or member service provider. The system and method may be able to incorporate any of the aforementioned institutions or any other institutions or persons in the payment processing industry.

The system and method may not be limited to specific types of merchant statement or business analysis. The system and method may be able to incorporate any type or form of merchant statement or business analysis.

One embodiment of the present invention can include a method, the method being run by a computing system, wherein a merchant (i) contacts a merchant services provider over an information network, (ii) prepares an application for payment processing services and transmits the application to the provider over the network which includes an e-signature signifying the agreement to enter into a contract if and when the provider accepts the rates the merchant desires to pay for payment processing services, (iii) enters a desired rate and sending the rate to the provider over the network after the application has been completed, signed, and transmitted to provider, and (iv) receives acceptance or denial of the rate and confirmation of the contract between the merchant and the provider over the network. As previously mentioned, the merchant will only be notified if the rate offered was acceptable if the merchant application passes underwriting. The method furthering including receiving notice the desired rate has not been accepted, and entering and transmitting a second rate that is higher than the first rate. The application can include terms and conditions that permits the merchant a finite number of chances to state a rate before being finally rejected or accepted by the provider.

Another embodiment of the present invention can include a method and a computing system wherein a provider (i) serves a website or provides a mobile application to a merchant permitting the merchant to apply for payment processing services, (ii) receives request to apply for payment processing services over a network, (iii) receives an application from the merchant including a signature assenting to the provider's terms and conditions, (iv) receives a set of desired rates from the merchant over the network, (v) compares the desired rates with acceptable rates by accessing rate information stored in memory, (vi) performs or has an underwriting function performed to verify the veracity and truthfulness of the merchant's application, and (vii) sends the merchant an acceptance of the desired rates and acceptance of the merchant's offer to enter into a contract applying the desired rates when the merchant's application passes underwriting.

Embodiments of the present invention can include any method conducted between computing devices wherein a merchant utilizing a first computing device requests payment processing services from a provider at rates proffered by the merchant, and wherein the provider utilizing an automated process on one or more computing devices accepts the proffered rate after determining the proffered rate is the same as or greater than the provider's minimum acceptable rate.

In one embodiment, a method for creating a binding contract between a merchant and a merchant services provider for payment processing services can include, but is not limited to, the steps of (i) soliciting a rate offer from the merchant for payment processing services, (ii) receiving an application including a plurality of data entries related to information about a business of the merchant, (iii) receiving a first rate offer from the merchant for payment processing services, (iv) extracting one or more of the plurality of data entries from the application, (v) generating a pricing structure for the merchant based on the extracted one or more data entries, the pricing structure including a baseline rate, (vi) performing a first underwriting analysis on the application, (vii) reviewing information related to hardware used by the merchant for payment processing from at least one data entry of the application, (viii) determining if the merchant will receive feedback on the first rate offer based on (a) the first underwriting analysis finding the application meets a predetermined set of requirements, and (b) the hardware of the merchant, (ix) comparing the first rate offer with the baseline rate of the pricing structure, and (x) completing one of the following steps: (a) accepting the first rate offer and creating a binding agreement between the merchant and the merchant services provider when the first rate is above the baseline rate and the hardware is acceptable, (b) declining the first rate offer when the first rate offer is below the baseline rate and sending a notification to the merchant indicating the first rate offer has been declined and soliciting a second rate offer when the hardware is acceptable, and (c) declining the first rate offer when the hardware of the merchant is not acceptable and sending a notification to the merchant indicating the deal is declined, the notification not mentioning if the first rate offer was acceptable.

In another embodiment, a method for creating a binding contract between a merchant and a merchant services provider for payment processing services can include, but is not limited to, the steps of (i) receiving an application including information about a business of the merchant, (ii) performing a first underwriting analysis on the application, (iii) soliciting a rate offer from the merchant for payment processing services when the first underwriting analysis finds the application meets a first set of requirements, (iv) determining a pricing structure for the merchant based on the first underwriting analysis, the pricing structure including a baseline rate, (v) receiving a first rate offer from the merchant, (vi) performing a second underwriting analysis on the application, (vii) soliciting information related to hardware used by the merchant for payment processing when the second underwriting analysis finds the application meets a second set of requirements, (viii) determining if the first rate offer will be analyzed based on (a) the second underwriting analysis finding the application meets the second set of requirements and (b) the hardware of the merchant, (ix) comparing the first rate offer with the baseline rate of the pricing structure, and (x) completing one of the following steps: (a) accepting the first rate offer and creating a binding agreement between the merchant and the merchant services provider when the first rate is above the baseline rate and the hardware is acceptable, and (b) declining the first rate offer when the first rate offer is below the baseline rate and sending a notification to the merchant indicating the first rate offer has been declined and soliciting a second rate offer.

The present invention can be embodied as devices, systems, methods, and/or computer program products. Accordingly, the present invention can be embodied in hardware and/or in software (including firmware, resident software, micro-code, etc.). Furthermore, the present invention can take the form of a computer program product on a computer-usable or computer-readable storage medium having computer-usable or computer-readable program code embodied in the medium for use by or in connection with an instruction execution system. In one embodiment, the present invention can be embodied as non-transitory computer-readable media. In the context of this document, a computer-usable or computer-readable medium can include, but is not limited to, any medium that can contain, store, communicate, propagate, or transport the program for use by or in connection with the instruction execution system, apparatus, or device.

The computer-usable or computer-readable medium can be, but is not limited to, an electronic, magnetic, optical, electromagnetic, infrared, or semiconductor system, apparatus, device, or propagation medium.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “software,” as used in this specification and the appended claims, refers to programs, procedures, rules, instructions, and any associated documentation pertaining to the operation of a system.

The term “firmware,” as used in this specification and the appended claims, refers to computer programs, procedures, rules, instructions, and any associated documentation contained permanently in a hardware device and can also be flashware.

The term “hardware,” as used in this specification and the appended claims, refers to the physical, electrical, and mechanical parts of a system.

The terms “computer-usable medium” or “computer-readable medium,” as used in this specification and the appended claims, refers to any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term “signal,” as used in this specification and the appended claims, refers to a signal that has one or more of its characteristics set or changed in such a manner as to encode information in the signal. It is to be appreciated that wireless means of sending signals can be implemented including, but not limited to, Bluetooth, Wi-Fi, acoustic, RF, infrared and other wireless means.

The term “merchant,” as used in this specification and the appended claims, refers to an individual, business, retailer, corporation, retailer, group of people, etc. desirous of establishing a merchant account to accept credit as payment for good or services provided to a customer.

The term “merchant services provider” or “provider,” as used in this specification and the appended claims, refers to a provider of merchant services including payment processing services. The provider can be a broker, a processor, a financial institution and/or an underwriter that receives and acts on a merchant's request for the possible establishment of a merchant account.

### An Embodiment of a Merchant Services Provider System

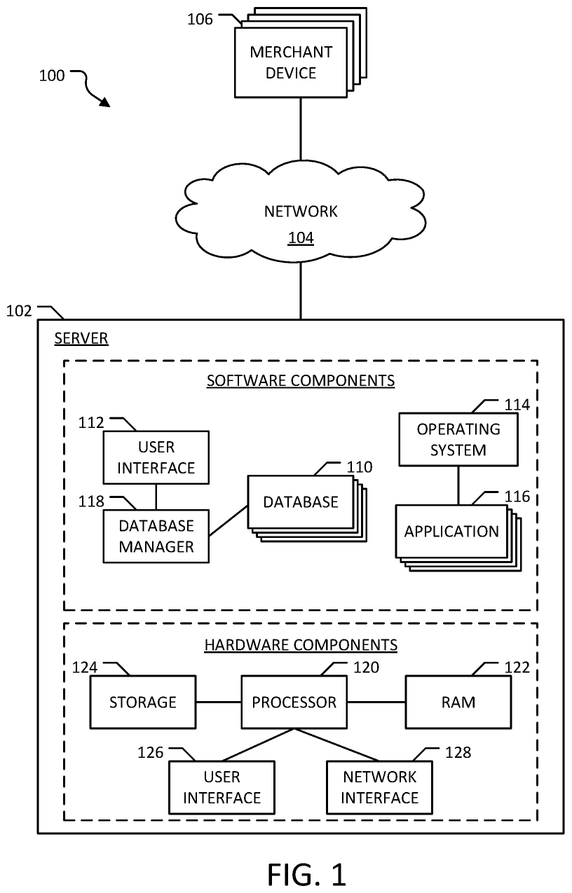

Referring to FIG. 1, a block diagram of an embodiment 100 of a system for creating a binding agreement between a merchant services provider and a merchant is illustrated. The system 100 can be implemented to provide a means for a merchant to create a merchant processing account with a merchant services provider. Typically, a merchant can present an offer of a rate the merchant may be willing to pay for payment processing services and the system 100 can be used to determine if the rate will be accepted.

As shown, the system 100 can include, but is not limited to, a server 102, a network 104, and a plurality of merchant devices 106. A mobile application provided by a merchant services provider can be adapted to run on the merchant devices 106. In some instances, the merchant services provider can provide a website accessible via the internet. A combination of a website and a mobile application can be implemented by the merchant services provider. The mobile application (or website) can be implemented to allow a merchant to enter data for an application to be reviewed by the merchant services provider.

Generally, data related to one or more merchants who have created an account with a merchant services provider can be stored in the server 102. Further, data and information related to underwriting and rate structures of the merchant services provider can be stored in the server 102. The data can be stored in one or more databases 110 of the server 102. In one example, data related to merchants can be stored in a separate database from data of the merchant services provider. In some instances, the data can be stored in databases remotely located from one another. It is to be appreciated that the data may be stored externally to the server 102. For instance, the databases 110 can be remotely located from the server 102.

Typically, a merchant can input information into a merchant services provider application on a merchant device 106 that can then be transferred to and stored in one of the databases 110. A unique identifier, preferences, and relevant information can be stored for each merchant in the server 102.

The server 102 can represent a server or another powerful, dedicated computer system that can support multiple user sessions. In some embodiments, the server 102 can be any type of computing device including, but not limited to, a personal computer, a game console, a smartphone, a tablet, a netbook computer, or other computing devices. In one embodiment, the server 102 can be a distributed system wherein server functions are distributed over several computers connected to a network. The server 102 can typically include a hardware platform and software components. In some instances, the merchant devices 106 may be implemented as the server 102.

The software components of the server 102 can include the one or more databases 110 which can store user information and data. The software components can also include an operating system 114 on which various applications 116 can execute. A database manager 118 can be an application that runs queries against the databases 110. In one embodiment, the database manager 118 can allow interaction with the databases 110 through an HTML user interface on a merchant device 106.

The hardware platform of the server 102 can include, but is not limited to, a processor 120, random access memory 122, and nonvolatile storage 124. The processor 120 can be a single microprocessor, multi-core processor, or a group of processors. The random access memory 122 can store executable code as well as data that can be immediately accessible to the processor. The nonvolatile storage 124 can store executable code and data in a persistent state.

The hardware platform can include a user interface 126. The user interface 126 can include keyboards, monitors, pointing devices, and other user interface components. The hardware platform can also include a network interface 128. The network interface 128 can include, but is not limited to, hardwired and wireless interfaces through which the server 102 can communicate with other devices including, but not limited to, the merchant devices 106.

The network 104 can be any type of network, such as a local area network, wide area network, or the Internet. In some cases, the network 104 can include wired or wireless connections and may transmit and receive information using various protocols.

The one or more merchant devices 106 can be any type of computing device on which a browser or software can operate. Examples of such devices can include, but are not limited to, desktop computers, laptop computers, tablet computers, mobile telephones, game consoles, network appliances, or any other web-enabled devices. In an embodiment, the merchant devices 106 can have various hardware platforms on which a browser can execute. The browser can be used to access the HTML user interface of the database manager 118. In one instance, the system can execute functional operations by virtue of service calls to a service-based processing system.

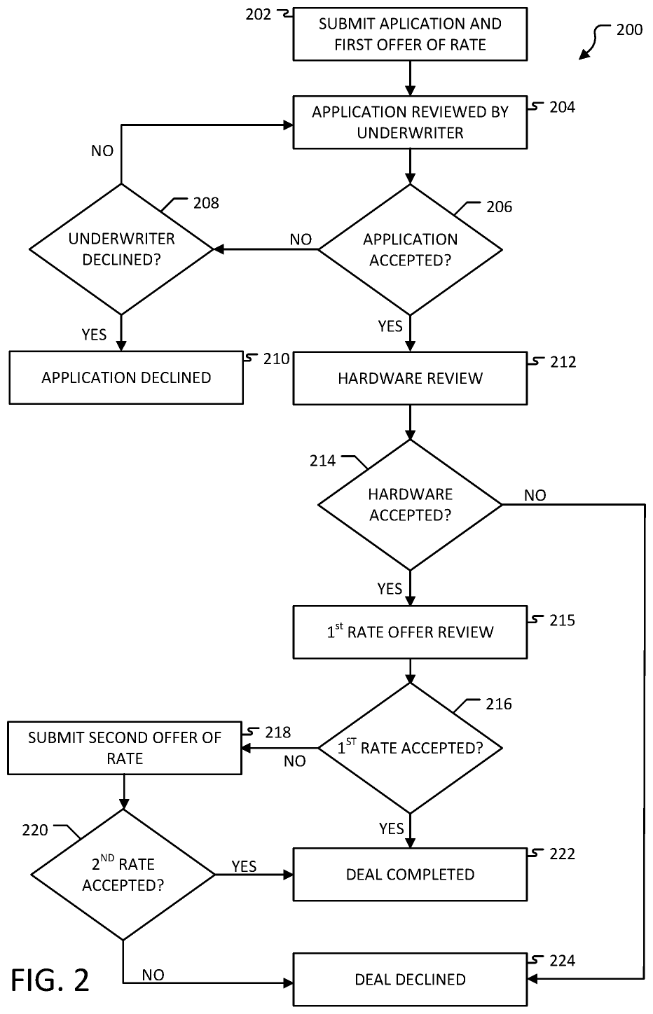

Referring to FIG. 2, a flowchart of one example method (or process) 200 of creating a binding agreement between a merchant and a merchant services provider is illustrated. Typically, the process 200 can be started after a merchant has registered and created a profile with a merchant services provider. The merchant services provider may solicit offers from potential merchants via advertising or other means. Of note, steps of the process 200 described below may be performed in a different order or simultaneously to one another. The order of the steps of the method 200 is not meant to be limiting.

In block 202, the merchant can fill out an application that includes information about their business and a rate they would be willing to pay for payment processing services. The application may include a plurality of data fields for the merchant to enter information into. After the application is completed and the merchant has entered a proposed first rate, the application and the first rate can be submitted. The data entered in the application can be sent to the server 102 via the network 104 from the merchant device 106. In one instance, the data entered by the merchant into the application can be extracted from the application when the application is sent to the provider.

In some embodiments, the merchant services provider can perform a soft underwriting analysis to verify the veracity of the information entered by the merchant. In some instances, a prompt to enter a rate in the mobile application (or website) may not be generated until the merchant services provider has completed the soft underwriting analysis. The merchant services provider may provide a graphical interface showing rates previously paid by the merchant or even rates (e.g., average rates) of similar merchants and what they are paying to help the merchant make a first offer.

Information requested and inputted by the merchant in the application can include, but is not limited to, general questions about the merchant, merchant data information, business information, contact information, address information, signer/guarantor information, ownership information, bank information, processing information, rates and pricing information, additional bankcard information, monthly fees information, equipment (or hardware) information, and legal and signatory information. General questions may include questions about business size (volume), business type (MCC code), and how many locations. The merchant data information requested may include referral partner and business name. The contact information requested may include contact first name, contact last name, email address, and phone number. The business information requested may include ownership type, doing business as (DBA) information, legal name of business, business start date, website address, phone number, fax number, and time-zone. The address information requested may include street address, city/state, zip code, country, if the mailing address is the same as the business address. The ownership information requested may include username, first name, last name, email address, title, ownership percentage, social security number, date of birth, phone number, mobile phone number, driver's license number, and residence address. The bank information requested may include bank name, account type, account usage, routing number, and account number. The processing information requested may include merchant statement analysis data/rates, industry MCC code, business description, average monthly volume, average annual volume, high ticket amount, when is card charged, refund policy, and seasonal business. The rates and pricing information request may include pricing type, card acceptance, and additional card types (e.g., Voyager, WEX, PIN debit, EBT, etc.). The additional bankcard information requested may include Discover program, American Express program, Visa qualified rate, Mastercard qualified rate, Discover qualified rate, American Express qualified rate, and authorization fee. The monthly fees information requested may include application fee, minimum processing fee, early termination fee, demand deposit account rejects (per item), statement fee (monthly), data breach fee (monthly), chargeback fee (per item), retrieval fee, annual fee, equipment rental fee, regulatory product fee, PCI non-compliance fee, PCI annual fee, wireless fee, wireless activation fee, dues and assessments, and passthrough interchange costs. The equipment (or hardware) information request may include equipment categories, type of equipment used, if equipment is needed, a network may be automatically linked based on equipment selected, if equipment is owned, shipping and payment questions. The legal and signatories section information request may include terms and conditions declaration and legal disclaimers. After the information has been inputted, the merchant may electronically sign the application document. The application document may include a statement that if the rate is accepted by the merchant services provider, a binding contract will be created.

In block 204, the application submitted by the merchant can be reviewed by an underwriter of the merchant services provider. The underwriting may be an analysis of the application submitted by the merchant to verify the veracity of the information provided in the application. In some instances, the underwriting may be near instant to speed up the process. For example, near instant underwriting may be based on a credit score of the signer/guarantor of the application. The underwriting can include, but is not limited to, verifying (i) an address, (ii) type of business, (iii) legal status, (iv) annual revenues, (v) signer/guarantor information, and (vi) other pertinent information. The underwriting analysis can be performed by the provider or an independent company or organization. The underwriting analysis can be carried out as an automated computer process, by one or more people, or a combination thereof.

Of note, after the application has been submitted, data from the application can be pulled and analyzed. Typically, information obtained from the application can be used to determine a baseline for rates acceptable by the merchant services provider. In one instance, the server 102 can draw proprietary data from the merchant application. The proprietary application data can be used to determine pricing algorithms. In one example, the proprietary data may include, but is not limited to, the MCC code of the merchant and the annual volume of the business. The merchant statement and business analysis data can be used for underwriting and current pricing can be included in pricing algorithms. Typically, all applicable application questions must be answered in order for a merchant to continue the process. The application may need to be e-signed by a signatory (e.g., guarantor) of the business.

The process 200 can move to decision block 206 next. In decision block 206, the application can be accepted or denied based on the underwriting. If the application is denied, the process 200 can move to decision block 208. If the application is accepted, the process 200 can move to block 212.

In decision block 208, a determination can be made if the underwriter denied the application or if the application was denied because vital information was missing or more information was needed to thoroughly analyze the application. If the application was denied by the underwriter, the process 200 can move to block 210. If the underwriter needs more information to complete the underwriting, the process can move back to block 204. In some instances, if during underwriting more information is determined to be needed, the merchant may log back in via a provided link and correct highlighted application items. For instance, the provider may send an email notification that information is missing and needs to be submitted prior to moving forward. Specific pending questions may also be asked and the merchant may then submit answers to those questions.

In block 210, the application can be declined and an email or other notification can be sent to the merchant to let them know that the application was declined and that they would not be able to move forward with securing a payment processing service. Of note, the merchant services provider may not indicate to the merchant if the proffered rate was acceptable or not. This may help deter merchants from rate shopping by inputting invalid information to solely see if a proffered rate would be accepted.

In block 212, information entered by the merchant in the application related to the hardware (e.g., payment processing equipment) they employ can be reviewed. Of note, the hardware may be a personal computing device on which a payment processing service is accessed over the internet. In such an instance, the merchant may have indicated in the application that they use a web-based processing service. It is to be appreciated that although hardware is mentioned, this includes personal (or business) computing devices used to access the web-based processing service and thus is referred to generally as hardware. In some instances, the merchant may indicate that they do not currently have any hardware. The merchant services provider may also provide an option for free processing equipment, hardware, or software in the application.

In some instances, the review of the hardware may be done automatically after the merchant submits the application. For instance, the merchant services provider can pull the hardware information from the application and review the information. In other instances, the hardware information may not be reviewed until after the underwriting has been completed. This may be done to save storage space and computing power in the server 102. In one example, if the merchant indicated in the application that they have proprietary point-of-sale hardware, the merchant services provider may need to contact the merchant to get more information on whether the point-of-sale hardware is compatible with the merchant services provider. In such an example, the process 200 may be placed on hold until the merchant services provider can make a final determination on whether they can accept an offer based on the hardware.

The process 200 can then move to decision block 214 and determine if the hardware of the merchant is acceptable. If the hardware is acceptable, the process 200 can move to block 215. If the hardware is not acceptable, the process can move to block 224.

In block 215, the rate offered by the merchant can be reviewed. Typically, after the merchant has submitted the application, data from the application can be pulled and a pricing structure can be generated based on the inputted information. In one instance, a baseline rate can be determined for the merchant. The rate proffered by the merchant can be compared to the baseline rate to see if the first rate offer is greater than or less than the baseline rate. Of note, in some instances, the actions in blocks 204, 212, and 215 can be performed simultaneously. In other instances, the actions in blocks 204, 212, and 215 can be performed in sequential order with one of the next steps only being performed after the previous step is completed.

In decision block 216, a determination can be made if the first rate offered by the merchant is acceptable to the merchant service provider. Generally, this can be based on the baseline rate generated for the merchant based on the information entered by the merchant in the application. In one example, if the first rate offered by the merchant is above the baseline rate, the first rate can be acceptable. If the first rate offered by the merchant is below or equal to the baseline rate, the first rate offered can be considered not acceptable. In one instance, when the first rate offered is above or equal to the baseline rate, then the first rate offered can be considered acceptable. If the first rate is acceptable, the process can move to block 222. In block 222, a contract between the merchant and the merchant services provider can be finalized and completed.

If the first rate is not acceptable to the provider, the process 200 can move to block 218. In block 218, the merchant can submit a second offer of a rate. The process 200 can then move to decision block 220.

In decision block 220, a determination can be made if the second rate offered by the merchant is acceptable to the merchant service provider. If the second rate is acceptable, the process can move to block 222. In block 222, as previously mentioned, a contract between the merchant and the merchant services provider can be finalized and completed. If the second rate is not acceptable, the process can move to block 224.

In block 224, the offers presented by the merchant can be rejected and a notification (e.g., email, text, etc.) can be sent to the merchant indicating that the deal was declined. Of note, the merchant services provider may not indicate to the merchant if the rate offer was acceptable when the deal is declined based on underwriting or hardware so that the merchant may not rate shop.

In some embodiments, time constraints can be placed on the merchant to provide information. If the information is not provided in the allotted time frame, the merchant can be denied a deal with the merchant services provider. For instance, the merchant may have a predetermined amount of time to finish the application and submit a rate offer. If the application is not finished within the predetermined amount of time, the merchant may be notified that their application was declined and they should resubmit a new application.

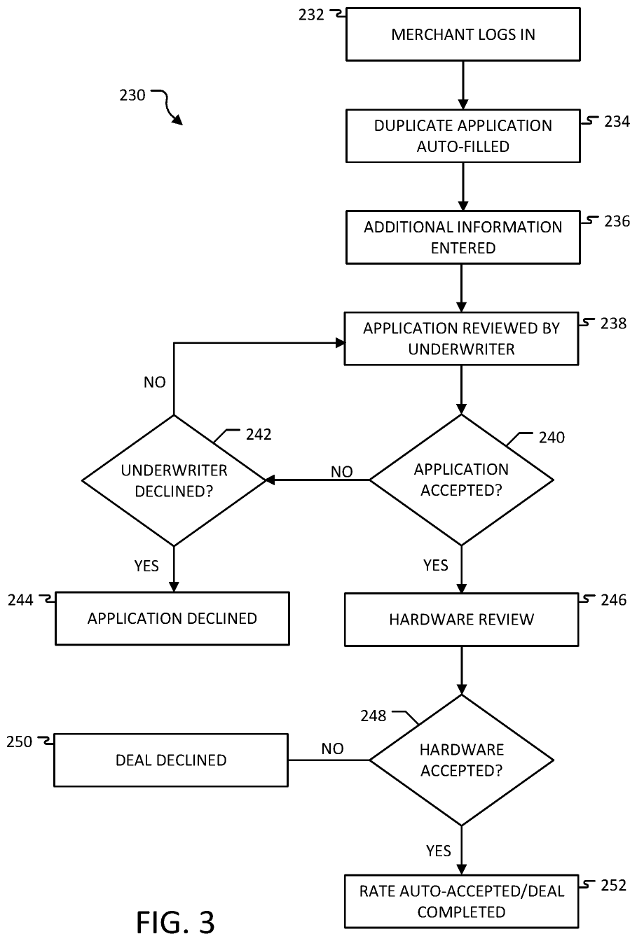

Referring to FIG. 3, a flowchart of a method (or process) 230 for adding an additional location of a similar business or a new business of a merchant for payment processing services is illustrated. Typically, a merchant that has already gone through the process of creating a binding agreement with the merchant services provider can add another location and agree on the same rates as previously agreed on. In some instances, a merchant may open an additional business different from a current business the merchant has agreed to a deal with the merchant services provider. In addition to a merchant being able to add locations for the same business, the merchant, where the same signatory/guarantor is signing, can be able to add another business with rates previously agreed to for a different business.

Merchants who have already completed a deal with the merchant services provider will have the option to add additional business locations with the same rates as previously agreed to. Of note, the additional location must be the same business and the signatory of the additional location must be the same as the signatory for the previously completed deal. As previously mentioned, the merchant may want to secure the same payment processing rates for a different business. In some instances, the merchant may need to verify an identity of the business and signatory by answering one or more security questions. For example, the merchant may need to input an Employer Identification Number, Social Security Number, or date of birth to confirm an identity of the merchant. The application (or website) may then create a duplicate account for the merchant and the additional location. The duplicate account can be auto-filled with information from the previous application submitted by the merchant. Typically, only information that may be the same for both locations can be auto-filled. The application may request the merchant to input additional information about the additional location for underwriting purposes. The merchant may then add additional hardware for the additional location. The application may then be signed by a signatory and can continue to underwriting. Of significant note, the merchant does not typically submit a rate offer. The rate can be duplicated and auto-filled from the previously agreed upon agreement. The merchant can see the rate, but may not be able to edit the rate. The application may ask the merchant to select an actionable button to accept the duplicate pre-filled rates. Once underwriting determines the application is accepted and the hardware used by the merchant at the additional location is acceptable, another deal can be completed between the merchant and the merchant services provider for the additional location or business.

Described hereinafter is one example of the method 230 for creating a binding agreement for a payment processing service between a merchant and a merchant services provider for an additional location.

In block 232, the merchant can login to the application or website. The merchant can use the previously created username and password to login.

In block 234, the merchant can select an option to add an additional location and information filled in an original application can be auto-filled into a new application.

In block 236, the merchant can enter additional information pertinent to the location being added. For instance, this may include an address, annual volume, etc. that may be singular to that location.

In block 238, the application can be reviewed by an underwriter. The process 200 can then move to decision block 240 after underwriting.

In decision block 240, a determination can be made if the application meets one or more requirements to get approval from the underwriter. If the application is accepted, the process 200 can move to block 246. If the application is not accepted, the process 230 can move to decision block 242.

In decision block 242, a determination can be made if the underwriter declined the application or if more information was needed to complete underwriting. If the underwriter declined the application, the process 230 can move to block 244. In block 244, the application can be declined and any potential deals for payment processing services at the additional location of the merchant can be declined. The process 230 can move back to block 238 if the underwriter needed more information.

In block 246, a review of the hardware used by the merchant at the additional location can completed. In some instances, the merchant services provider can get verbal confirmation on the type of hardware used by the merchant at the additional location (or new business).

In decision block 248, a determination of whether the hardware used by the merchant at the additional location is acceptable can be made. If the hardware is not acceptable, the process 230 can move to block 250. In block 250, the deal can be declined and the merchant can be notified that the deal has been declined based on the hardware. If the hardware is acceptable, the process 230 can move to block 252. In block 252, the previously accepted rate by the merchant services provider can be accepted again and a deal can be completed between the merchant and the merchant services provider for payment processing services at the additional location.

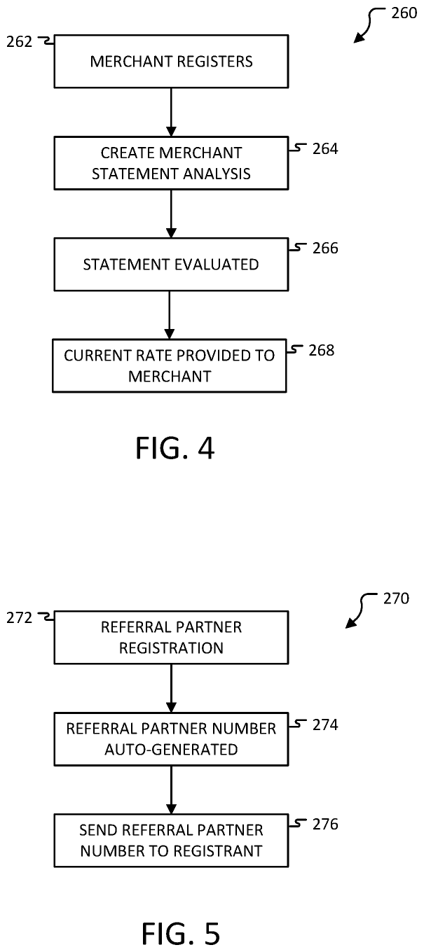

Referring to FIG. 4, a flowchart of a method (or process) 260 for performing a merchant statement analysis requested by a merchant is illustrated. The merchant statement analysis can simply be a guide for merchants that do know or understand their current payment processing rates. Merchants seeking to create a binding agreement with the merchant services provider would not be required to complete statement analysis. In some instance, a link on a homepage of the website or a feature of the application can include the merchant statement analysis function. Typically, business profile question data can be collected from the merchant. The merchant may also upload payment processing statements and data for analysis by the website (or application). Data related to the merchant statement analysis can be stored for later use when completing the application of a merchant. One or more algorithms and analysis techniques can be applied to the payment processing statements to determine a current rate(s) being paid by the merchant for payment processing services. The current rate being paid by the merchant can be stored and used as a guide for the merchant when they are submitting a rate offer. In some instances, statement analysis data can be used for underwriting purposes. The statement analysis can also be used as rate parameters for pricing algorithms used by the application (or website).

Described hereinafter is one example implementation of the method 260 for performing a merchant statement analysis for a merchant.

In block 262, a merchant can register via an application or website.

In block 264, the merchant can request a merchant statement analysis. Typically, the merchant can upload or provide one or more banking statements or processing statements which includes amounts charged (or paid) for payment processing services.

In block 266, the provided statements can be evaluated and a payment processing rate can be determined based on those statements.

In block 268, a current rate the merchant is paying for payment processing services can be provided to the merchant.

Referring to FIG. 5, a flowchart of a method (or process) 270 for creating a referral partner account with a merchant services provider is illustrated. Referral partners may be paid a set commission bonus based on merchant activations with the merchant services provider. Of note, referral partner commission bonuses can vary based on one or more factors determined by the merchant services provider. In some instances, the referral partner system may not be limited only to commission bonuses. For instance, the referral partner system could pay out earned residual income to referral partners. Of note, the referral partner account is not limited to a select group of individuals or entities. In some instances, merchants can be referral partners and so can independent sales contractors.

Described hereinafter is one example implementation of the method 270 for creating a referral partner account.

In block 272, a user can register for a referral partner account. The user can finish the registration via an application or a website.

In block 274, a referral partner number can be auto-generated for the user.

In block 276, the referral partner number can be sent to the user.

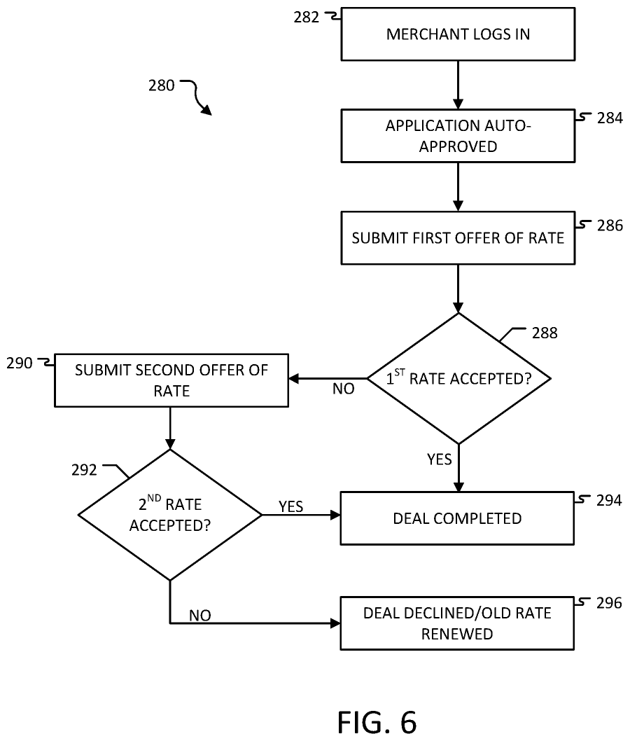

Referring to FIG. 6, a flowchart of a method (or process) 280 for retaining a merchant is illustrated. The method 280 can be implemented for a merchant who previously completed a deal with the merchant services provider and the previously completed deal may be coming to an end of the agreed upon term. The merchant can complete a new deal when the previous deal may be ending without going through the process 200 again.

In block 282, a merchant can log-in to the web site (or mobile application) of the merchant services provider. The merchant may be prompted to select whether they want to submit a rate offer for an extended term of their previously agreed upon deal. Alternatively, the merchant may be prompted to select if they want to try to get a new rate or keep the current rate they already have for an extended term.

In block 284, a new application can be auto-filled from the previous application of the merchant and can be automatically approved. In some instances, the merchant may be notified that underwriting needs to be completed before moving forward. For example, one or more factors from the previous contract may have changed based on either the merchant or merchant services provider requiring underwriting to be needed before moving forward.

In block 286, the merchant can submit a first rate offer. The merchant services provider may provide a graphical interface showing rates previously paid by the merchant or even rates (e.g., average rates) of similar merchants and what they are paying to help the merchant make a first offer.

The process 280 can move to decision block 288 after the merchant has submitted a first rate offer. In decision block 288, the first offer can either be accepted or declined. If the first rate offer is accepted, the process 280 can move to block 294. If the first rate offer is declined, the process 280 can move to block 290. In block 296, a deal can be completed and a binding contract can be affirmed between the merchant and merchant services provider for the new rate.

If the first rate offer was declined, the merchant can submit a second rate offer in block 290.

The process 280 can move to decision block 292 after the merchant submits the second rate offer. In decision block 292, the second rate offer can either be accepted or declined. If the second rate offer is accepted, the process 280 can move to block 294. If the second rate offer is declined, the process 280 can move to block 296.

As previously mentioned, in block 294, a deal can be completed and a binding contract can be affirmed between the merchant and merchant services provider for the approved rate and a new term.

In block 296, the deal can be declined by the merchant services provider. In some instances, a contract may then be automatically agreed upon for the previous rate paid by the merchant. In another instance, the merchant may have the option of agreeing to the previously agreed upon rate and a deal can be completed for a new term.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

1. A method for creating a binding contract between a merchant and a merchant services provider for payment processing services, the method comprising the steps of:
soliciting a rate offer from the merchant for payment processing services;
receiving an application including a plurality of data entries related to information about a business of the merchant;
receiving a first rate offer from the merchant for payment processing services;
extracting one or more of the plurality of data entries from the application;
generating a pricing structure for the merchant based on the extracted one or more data entries, the pricing structure including a baseline rate;
performing a first underwriting analysis on the application;
reviewing information related to hardware used by the merchant for payment processing from at least one data entry of the application;
determining if the merchant will receive feedback on the first rate offer based on (i) the first underwriting analysis finding the application meets a predetermined set of requirements, and (ii) the hardware of the merchant;
comparing the first rate offer with the baseline rate of the pricing structure; and
completing one of the following steps:
accepting the first rate offer and creating a binding agreement between the merchant and the merchant services provider when the first rate is above the baseline rate and the hardware is acceptable;
declining the first rate offer when the first rate offer is below the baseline rate and sending a notification to the merchant indicating the first rate offer has been declined and soliciting a second rate offer when the hardware is acceptable; and
declining the first rate offer when the hardware of the merchant is not acceptable and sending a notification to the merchant indicating the deal is declined, the notification not mentioning if the first rate offer was acceptable.

2. The method of claim 1, the method further including the steps of:
receiving a second rate offer from the merchant;
comparing the second rate offer with the baseline rate of the pricing structure;
completing one of the following steps:
accepting the second rate offer and creating a binding agreement between the merchant and the merchant services provider when the second rate is above the baseline rate; and
declining the second rate offer when the second rate is below the baseline rate and sending a notification to the merchant that the deal is declined.

3. The method of claim 1, wherein the application includes at least one data entry related to (i) an annual volume of the business; and (ii) a merchant category code of the business.

4. The method of claim 3, wherein the pricing structure is based on the annual volume of the business of the merchant.

5. The method of claim 4, wherein the pricing structure is further based on the merchant category code of the business.

6. The method of claim 1, wherein the application includes a signature by a signatory of the business assenting to terms and conditions of the merchant services provider.

7. The method of claim 1, further including the steps of:
soliciting a rate offer from a second merchant for payment processing services;
receiving a second application including a plurality of data entries related to information about a business of the second merchant;
receiving a first rate offer from the second merchant for payment processing services;
extracting one or more of the plurality of data entries from the second application;
generating a second pricing structure for the second merchant based on the extracted one or more data entries of the second application, the second pricing structure including a second baseline rate;
performing an underwriting analysis on the second application;
reviewing information related to hardware used by the second merchant for payment processing from at least one data entry of the second application;
determining if the second merchant will receive feedback on the first rate offer based on (i) the underwriting analysis finding the second application meets a predetermined set of requirements, and (ii) the hardware of the second merchant;
comparing the first rate offer with the second baseline rate of the second pricing structure; and
completing one of the following steps:
accepting the first rate offer and creating a binding agreement between the second merchant and the merchant services provider when the first rate is above the second baseline rate and the hardware is acceptable;
declining the first rate offer when the first rate offer is below the second baseline rate and sending a notification to the second merchant indicating the first rate offer has been declined and soliciting a second rate offer when the hardware is acceptable; and
declining the first rate offer when the hardware of the second merchant is not acceptable and sending a notification to the second merchant indicating the deal is declined, the notification not mentioning if the first rate offer was acceptable.

8. The method of claim 1, wherein the predetermined set of requirements includes verifying a business address, a business type, and a legal status of the business.

9. The method of claim 8, wherein the predetermined set of requirements further includes verifying a social security number of a signatory of the merchant.

10. A method for creating a binding contract between a merchant and a merchant services provider (MSP) for payment processing services, the method comprising the steps of:
by the MSP, soliciting a rate offer from the merchant for payment processing services;
by the merchant, submitting an application for payment processing services;
by the merchant, submitting a first rate offer;
by the MSP, receiving the application including a plurality of data entries related to information about a business of the merchant;
by the MSP, receiving the first rate offer from the merchant for payment processing services;
by the MSP, extracting one or more of the plurality of data entries from the application;
by the MSP, generating a pricing structure for the merchant based on the extracted one or more data entries, the pricing structure including a baseline rate;
by the MSP, performing an underwriting analysis on the application;
by the MSP, reviewing information related to hardware used by the merchant for payment processing from at least one data entry of the application;
by the MSP, determining if the merchant will receive feedback on the first rate offer based on (i) the first underwriting analysis finding the application meets a predetermined set of requirements, and (ii) the hardware of the merchant;
by the MSP, comparing the first rate offer with the baseline rate of the pricing structure; and
by the MSP, completing one of the following steps:
accepting the first rate offer and creating a binding agreement between the merchant and the merchant services provider when the first rate is above the baseline rate and the hardware is acceptable;
declining the first rate offer when the first rate offer is below the baseline rate and sending a notification to the merchant indicating the first rate offer has been declined and soliciting a second rate offer when the hardware is acceptable; and
declining the first rate offer when the hardware of the merchant is not acceptable and sending a notification to the merchant indicating the deal is declined, the notification not mentioning if the first rate offer was acceptable.

11. The method of claim 10, the method further including the steps of:
by the merchant, submitting a second rate offer;
by the MSP, receiving the second rate offer from the merchant;
by the MSP, comparing the second rate offer with the baseline rate of the pricing structure;
by the MSP, completing one of the following steps:
accepting the second rate offer and creating a binding agreement between the merchant and the merchant services provider when the second rate is above the baseline rate; and
declining the second rate offer when the second rate is below the baseline rate and sending a notification to the merchant that the deal is declined.

12. The method of claim 10, wherein the underwriting analysis is completed by an underwriting provider.

13. The method of claim 10, wherein the rate for payment processing services is based on an interchange-plus pricing structure.

14. The method of claim 13, wherein the step of submitting a first rate offer by the merchant includes providing a basis point percentage and a transaction fee.

15. The method of claim 14, wherein (i) the baseline rate includes a baseline basis point percentage and a baseline transaction fee; and (ii) the first rate offer must be above the baseline basis point percentage and the baseline transaction fee to be accepted.

16. The method of claim 10, wherein the pricing structure is based on an annual volume of the business and a merchant category code of the business.

17. The method of claim 10, the method further including the steps of:
by the MSP, confirming the type of hardware used by the merchant; and
by the MSP, completing one of the following steps:
declining a deal with the merchant and sending a notification to the merchant that the deal has been declined without including whether the first rate offer was accepted when the hardware is not acceptable; and
proceeding to the step of comparing the first rate offer with the baseline rate of the pricing structure when the hardware is acceptable.

18. The method of claim 10, wherein the underwriting is found acceptable based on a credit score of the merchant.

19. The method of claim 10, wherein the merchant has a predetermined amount of time set by the merchant services provider to submit the application and the first rate offer after creating an account with the merchant services provider.

20. A system for creating a binding contract between a merchant and a merchant services provider for payment processing services, the system comprising:
a first computing device having at least one computer-readable storage media having stored thereon computer executable instructions that, when executed by the first computing device, causes the system to perform one or more steps of a method;
a second computing device having at least one computer-readable storage media having stored thereon computer executable instructions that, when executed by the second computing device, causes the system to perform one or more steps of the method;
the method comprising the steps of:
by the first computing device, soliciting a rate offer from the merchant for payment processing services;
by the second computing device, submitting an application for payment processing services;
by the first computing device, receiving the application including a plurality of data entries related to information about a business of the merchant;
by the second computing device, submitting a first rate offer;
by the first computing device, receiving the first rate offer from the merchant for payment processing services;
by the first computing device, extracting one or more of the plurality of data entries from the application;
by the first computing device, generating a pricing structure for the merchant based on the extracted one or more data entries, the pricing structure including a baseline rate;
by the first computing device, performing a first underwriting analysis on the application;
reviewing information related to hardware used by the merchant for payment processing from at least one data entry of the application;
by the first computing device, determining if the merchant will receive feedback on the first rate offer based on (i) the first underwriting analysis finding the application meets a predetermined set of requirements, and (ii) the hardware of the merchant;
by the first computing device, comparing the first rate offer with the baseline rate of the pricing structure; and
by the first computing device, completing one of the following steps:
accepting the first rate offer and creating a binding agreement between the merchant and the merchant services provider when the first rate is above the baseline rate and the hardware is acceptable;
declining the first rate offer when the first rate offer is below the baseline rate and sending a notification to the merchant indicating the first rate offer has been declined and soliciting a second rate offer when the hardware is acceptable; and
declining the first rate offer when the hardware of the merchant is not acceptable and sending a notification to the merchant indicating the deal is declined, the notification not mentioning if the first rate offer was acceptable.

21. The method of claim 1, the method further including the steps of:
sending a notification to the merchant that a deal is declined based on the underwriting analysis denying the application.
